(19) United States
(12) Patent Application Publication
(10) Pub. No.: US 2013/0046649 A1
(43) Pub. Date: Feb. 21, 2013

(54) Method and System for Providing A Hybrid Descending-Price Auction

(71) Applicant: Larry Dague, Highland Village, TX (US)

(72) Inventor: Larry Dague, Highland Village, TX (US)

(21) Appl. No.: 13/588,719

(22) Filed: Aug. 17, 2012

Related U.S. Application Data
(60) Provisional application No. 61/524,513, filed on Aug. 17, 2011.

(51) Int. Cl. G06Q 30/08

(52) U.S. Cl. 705/26.3

(57) ABSTRACT

A method and system is provided for facilitating a hybrid descending-price auction. Items are offered at an initial price, which is then decreased over time at a dynamically variable rate until the price falls to a reserve price. Participants may choose to end the auction at any time by placing a bid at the current price, with the item being awarded to the first participant to bid the current price. Participants may also choose to place a stop bid for a value lower than the current price but greater than the reserve price, such that if the price decreases to the stop bid value, the item will be awarded to that participant. However, if another participant places a bid or a stop bid valued higher than the previous stop bid, the subsequent participant will be awarded the item.

### CROSS REFERENCE TO RELATED APPLICATIONS

The present application claims the benefit under 35 U.S.C. §119(e) of U.S. Provisional Patent Application Ser. No. 61/524,513 filed Aug. 17, 2011 and entitled “Method and System for Providing a Hybrid Descending-Price Auction,” which is incorporated herein by reference for all purposes.

### TECHNICAL FIELD

The present disclosure relates generally to an interactive communications system, and in particular, to a descending-price auction system that allows remote bidders to participate on a real time basis.

### BACKGROUND

Auctions are efficient mechanisms for selling goods and services. Conventional auctions consist of a physical gathering of participants assembled together within a set forum. Alternatively, online auctions enable individuals dispersed over a wide geographic area to participate in the auction. Online auctions have become popular for many reasons, among them the elimination of the perceived aggressive and intimidating environment of a physical auction. Both conventional auctions and online auctions can be conducted through various formats, including ascending-price auctions and descending-price auctions.

Ascending-price auctions, or English auctions, begin with an initial asking price that is increased by each subsequent bid. The item is awarded to the highest bid placed before the time period of the auction elapses. Ascending-price auctions may become tedious for both sellers and participants, in that the auctions last for a period of time, wherein only the last minute matters. As such, most of the action is centered on the last few minutes and a last second bid often wins the auction.

Descending-price auctions, or Dutch auctions, are the type where the auction begins with a comparatively high asking price that is steadily decreased until a participant is willing to accept a then-current price by making a bid, or a predetermined reserve price is met. Typically, a descending-price auction awards an item to the first actual bidder, as opposed to participants who simply monitor the auction but choose not to bid at the then-current price. This type of auction can be disadvantageous to those participants who wish to make a bid of a fixed value, but who are unable to continually access the auction at the time the current bid price falls to the desired fixed value.

### SUMMARY

Embodiments of the present disclosure generally facilitate hybrid descending-price auction methods and systems, where all participants are allowed to compete fairly in the auction process, while maintaining the excitement of “last minute bidding” throughout the duration of the auction.

According to one embodiment of the present disclosure, items are offered at an initial price, which is then decreased over time at a dynamic rate until the price falls to a reserve price, a price below which the item will not be sold. Remote participants may choose to end the auction at any time by placing a bid at the then-current price, with the item being awarded to the first remote participant to bid the then-current price. Remote participants may also choose to place an offer to buy or a stop bid (referred to herein as a stop bid) for a value lower than the then-current price but greater than the reserve price, such that if the price decreases to the stop bid value, the item will be awarded to that remote participant. However, if another remote participant places a bid or a stop bid valued higher than the previous stop bid, the subsequent remote participant will be awarded the item.

In another embodiment, a computer system is configured for managing an auction for an item over a network, comprising at least one processor to execute program instructions and to process logic for setting a current price for the item; displaying the current price and enabling bidding at the current price; continually decreasing and displaying the current price until a bid is received at the then-current asking price, and awarding the item to the bidder at the then-current price; and maintaining and comparing stop bids.

In another embodiment, a machine-readable medium is provided having data stored thereon representing instructions which, when executed implement the steps of setting a current price for the item; displaying the current price and enabling bidding at the current price; continually decreasing and displaying the current price until a bid is received at the then-current asking price, and awarding the item to the bidder at the then-current price; and maintaining and comparing stop bids.

### BRIEF DESCRIPTION OF THE DRAWINGS

For a more complete understanding of this disclosure and its features, reference is now made to the following description, taken in conjunction with the accompanying drawings, in which:

FIG. 1 is a block diagram of a computer environment for implementing a hybrid descending-price auction system in accordance with one embodiment of the present disclosure;

FIG. 2 is a somewhat simplified flow diagram illustrating a method of conducting a hybrid descending-price auction in accordance with one embodiment of the present disclosure; and

FIG. 3 is a somewhat simplified flow diagram illustrating a method of conducting a hybrid descending-price auction in accordance with another embodiment of the present disclosure.

### DETAILED DESCRIPTION

The present disclosure generally provides an efficient, yet dynamic system and method of facilitating a hybrid descending-price auction to help maintain and increase the participants' interest and excitement.

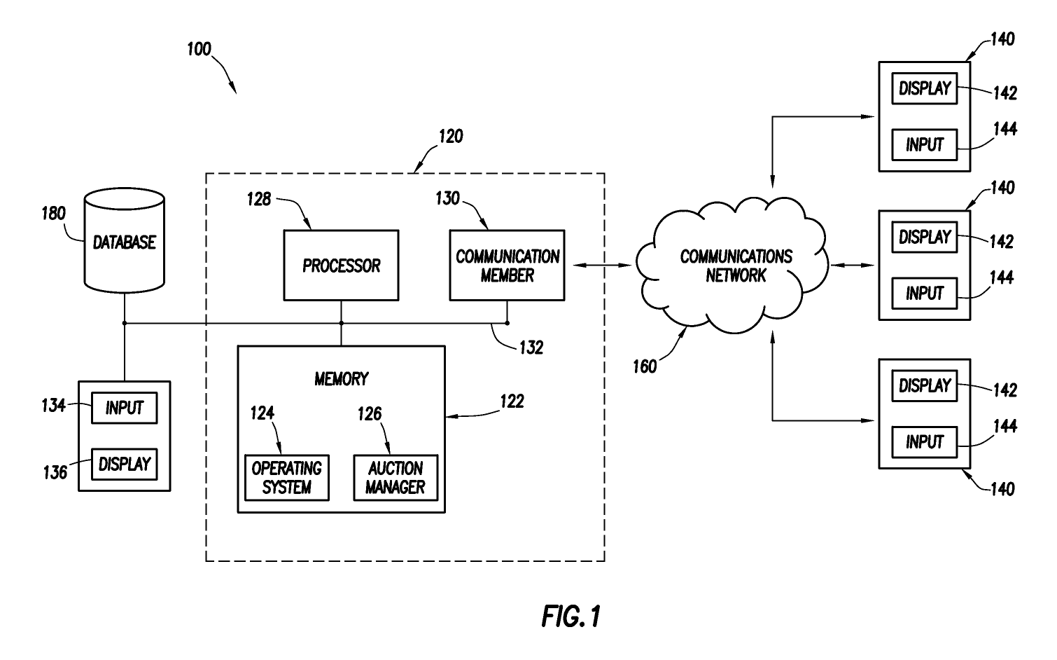

FIG. 1 generally illustrates a dynamic remote auction bidding system 100 for conducting a hybrid descending-price auction according to one embodiment of the present disclosure. It should be understood that system 100 shown in FIG. 1 is for illustrative purposes only and that any other suitable system or subsystem could be used in conjunction with or in lieu of system 100 according to one embodiment of the present disclosure.

System 100 allows a plurality of remote participants 140 to communicate and interact with auction server 120 through a communications network 160.

Auction server 120 may generally include a computer system having a memory 122, at least one processor 128, and a communication member 130. Each element of the auction server 120 is coupled to bus 132 or other communication mechanism for relaying information.

Memory 122 comprises both random access memory (RAM) and read-only memory (ROM). Memory 122 may be employed to store program information, instructions to be executed by processor 128, and temporary information during execution of instructions by processor 128.

Within memory 122 reside operating system 124 and auction manager 126. Operating system 124 may be employed as a software platform upon which the hybrid descending-price auction application programs may execute. Auction manager 126 may generally include program instruction sequences for managing hybrid descending-price auctions.

Processor 128 may be employed to execute the program instructions that are stored by memory 122. Processor 128 is capable of identifying and monitoring each remote participant 140 as well as communicating with each remote participant 140 via communications member 130 and communications network 160.

Communication member 130 comprises conventional hardware and software that facilitates coupling auction server 120 to communications network 160.

In an embodiment, auction server 120 is coupled to a database 180. Auction server 120 may store parameters associated with one or more items being auctioned in the database 180. Parameters stored in database 180 may include item descriptions, initial price, reserve price, auction time period, and viewer price drop parameters, as further described below. Auction server 120 may also store information corresponding to participants in the database 180.

Auction server 120 may also be coupled to at least one input device 134, to allow a user to communicate auction instructions and parameters, and at least one display 136, to display information to a user, according to one embodiment of the present disclosure.

Remote participants 140 access auction information by communicating with auction server 120 through communications network 160.

Each remote participant 140 may generally include at least one display 142, to view auction items and associated information, and at least one input device 144, to communicate with auction server 120.

In operation, remote participants 140 may be located in geographically distant locations, however, remote participants 140 may include any one in a separate location, including persons located in a separate room in the same building.

Any of input devices 134 and/or input devices 144 may be an alphanumeric keyboard, mouse, trackball, cursor direction keys, touch pad, Touch Tone telephone, wireless telephone, two-way pager, personal digital assistant, voice recognition device, other suitable data input device, or any combination thereof.

Any of displays 136 and/or displays 142 may be a cathode ray tube (CRT) monitor, liquid crystal display (LCD) monitor, plasma screen, high definition television (HDTV) screen, conventional television screen, projection television screen, video conferencing display, other suitable display, or any combination thereof.

The present disclosure is related to the use of auction server 120 to administer hybrid descending-price auctions, as described herein. According to one embodiment of the present disclosure, execution of the instructions stored in memory 122 allows processor 128 to implement the functionality described above. In alternative embodiments, hardware circuitry may be used in conjunction with or in lieu of software instructions to implement the present disclosure. However, the present disclosure is not limited to any specific combination of hardware circuitry and/or software.

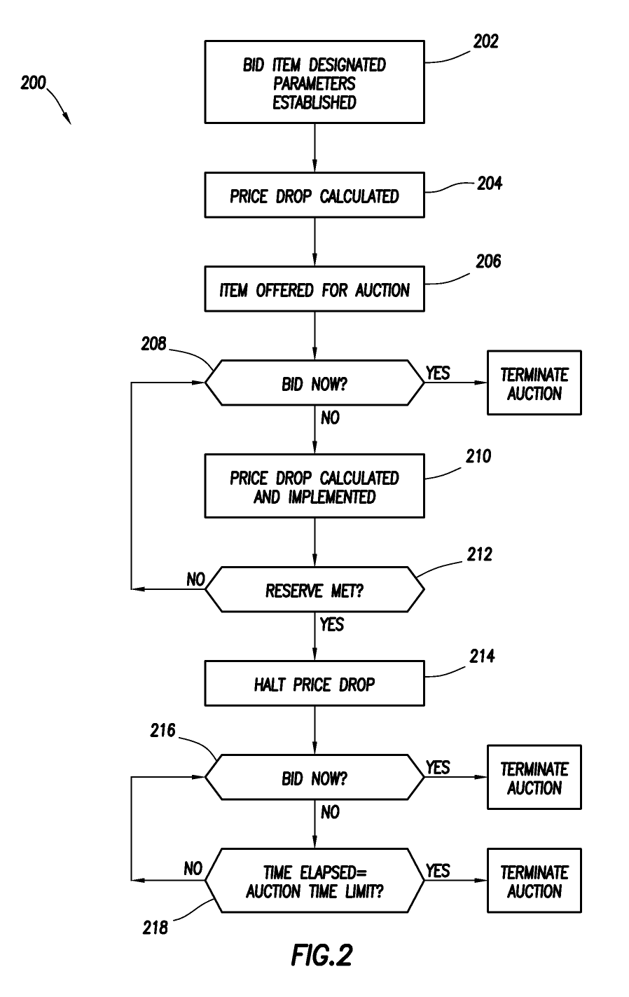

FIG. 2 is a somewhat simplified flow diagram illustrating method 200 of providing a hybrid descending-price auction according to one embodiment of the present disclosure. It should be understood that method 200 shown in FIG. 2 is for illustrative purposes only and that any other suitable method or sub-method could be used in conjunction with or in lieu of method 200 according to one embodiment of the present disclosure. It should also be understood that the steps of method 200 could be performed in any suitable order or manner.

In an embodiment, method 200 begins in step 202 with a user designating an item for bid. The user may establish one or more initial parameters associated with an item. Parameters may generally include an item description, an initial price, a reserve price (the lowest acceptable price), the time period for the auction, and viewer related price drop speeds.

In step 204, auction manager 126 analyzes the user-inputted parameters and calculates the price drop rate. In an embodiment, auction manager 126 may calculate the standard drop rate with an algorithm that is based on price and time. For example, if an item has an initial price of $125.00, a reserve price of $25.00, and an auction time period of 1 week, the standard drop rate would be $0.0099 per minute ($100 divided by 10,080 minutes in one week). Of course, it may be desirable to round the drop rate to the nearest cent per unit of time.

In another embodiment, the price drop rate could be adjusted such that the price drop rate prior to decreasing to a predetermined intermediate value, such as $50 in the above example, would be greater than the price drop rate once the predetermined value has been reached. In yet another embodiment, more than one predetermined intermediate value could be selected such that the price drop rate is adjusted multiple times throughout the auction based on user-selected criteria. For example, as each progressively lower intermediate value is reached, the price drop rate (and/or the multiplying factor employed by auction manager 126) could be progressively decreased in order to extend the life of the auction and thereby increase the likelihood of a bid.

In alternate embodiments, auction manager 126 may adjust the price drop rate with an algorithm that manipulates the standard drop rate based on the number of viewers of the item. By way of example but not limitation, if no participant has viewed the item in a predetermined time frame, such as 5 minutes, then the price drop rate may decrease to 0 (or close to 0). This functionality may substantially prevent items from losing significant value at times where few, if any, participants are actively engaged in the auction—for example, at very late hours of the night or holidays. Conversely, if a predetermined number of people, such as 5 people, have viewed the item in a predetermined time frame, such as 5 minutes, then the price drop rate will increase by a predetermined multiplier, such as 1.5×standard drop rate. The above are merely examples.

Additionally, the price drop rate may be manipulated based on specific characteristics of a viewer in accordance with one embodiment of the present disclosure. For example, if a participant is a registered member of the Internet website and he views an item, the price drop rate may increase by a predetermined multiplier. This functionality may substantially prevent items from losing value based on views by participants who are less likely to make a bid. As another example, if a participant has a history of bidding on other items and he views an item, the price drop rate may increase by a predetermined multiplier. As yet another example, if a participant has a history of bidding at relatively higher prices on other items and he views an item, the price drop rate may increase by a predetermined multiplier. In still another example, if a participant has viewed the auction multiple times, the price drop rate may increase by a predetermined multiplier every time that particular participant views the auction (and this multiplier may increase each time that participant views the auction).

In another embodiment, auction manager 126 may adjust the price drop rate with an algorithm based on overall Internet website activity. For example, if 20% of the Internet website participants have viewed the item during a predetermined time period, such as 5 minutes, then the price drop rate will increase by a predetermined multiplier, such as 5×standard drop rate. Conversely, if only 5% of the Internet website participants have viewed the item during a predetermined time period, such as 5 minutes, then the price drop rate will only increase by a predetermined multiplier, such as 1.5×standard drop rate. Again, the above are merely examples.

As the above makes clear, the price drop rate may be calculated in a number of different ways and any other suitable scheme for adjusting and/or controlling the decrease in price over time may be employed without deviating from the scope of the present disclosure.

In step 206, auction manager 126 engages the auction by displaying the item, item description, and a current asking price equal to the initial price defined by the user-inputted parameters. Optionally, auction manager 126 may also display the reserve price depending on whether it is deemed desirable for the remote participants 140 to know the value of the reserve price, if any.

In step 208, remote participants 140, viewing the item on their displays 142, may bid on an item at the then-current price by selecting “Bid Now” (or some other bidding mechanism) through their input devices 144. Once auction manager 126 determines a bid has been received at the current price, the auction manager 126 terminates the auction and awards the item to the bidder at the bid price.

In an embodiment, auction manager 126 may notify the winner by display message, electronic mail message, automated telephone message, instant message, text message, other suitable means, or any combination thereof. If desired, auction manager 126 may also notify one or more remote participants 140 who viewed the item by display message, electronic mail message, automated telephone message, instant message, text message, other suitable means, or any combination thereof.

If auction manager 126 determines a bid is not received at the current price, the price drop rate is calculated and implemented as shown in step 210. In particular, the price drop rate may be calculated according to any suitable scheme for adjusting and/or controlling the decrease in price over time. In this manner, the price drop rate may be dynamically adjusted during the auction.

Each time the price drops, auction manager 126 determines whether the current price is equal to the reserve price, as shown in step 212.

If the reserve price has not been met, then the process reverts to step 208.

In step 214, if it is determined that the reserve price has been met, auction manager 126 halts the price drop. Auction manager 126 may display that the reserve price has been met and/or notify one or more remote participants 140 who have viewed the item, by display message, electronic mail message, automated telephone message, instant message, text message, other suitable means, or any combination thereof, that the reserve price has been met.

In one embodiment, auction manager 126 may immediately terminate the auction when the reserve price has been met. Alternatively, however, as shown in FIG. 2, auction manager 126 may extend the auction for a predetermined period of time. According to this embodiment, in step 216 auction manager 126 recursively determines whether a bid is received at the reserve price before the auction time period has elapsed. If auction manager 126 determines a bid has been received at the reserve price, the auction manager 126 terminates the auction and awards the item to the bidder at the reserve price.

In an embodiment, auction manager 126 may notify the winner by display message, electronic mail message, automated telephone message, instant message, text message, other suitable means, or any combination thereof. If desired, auction manager 126 may also notify one or more remote participants 140 who viewed the item by display message, electronic mail message, automated telephone message, instant message, text message, other suitable means, or any combination thereof.

If auction manager 126 determines that no bids are received equal to or greater than the reserve price and the time elapsed is equal to or greater than the user-inputted auction time period, then auction manager 126 may terminate the auction and the item may not be awarded, as shown in step 218.

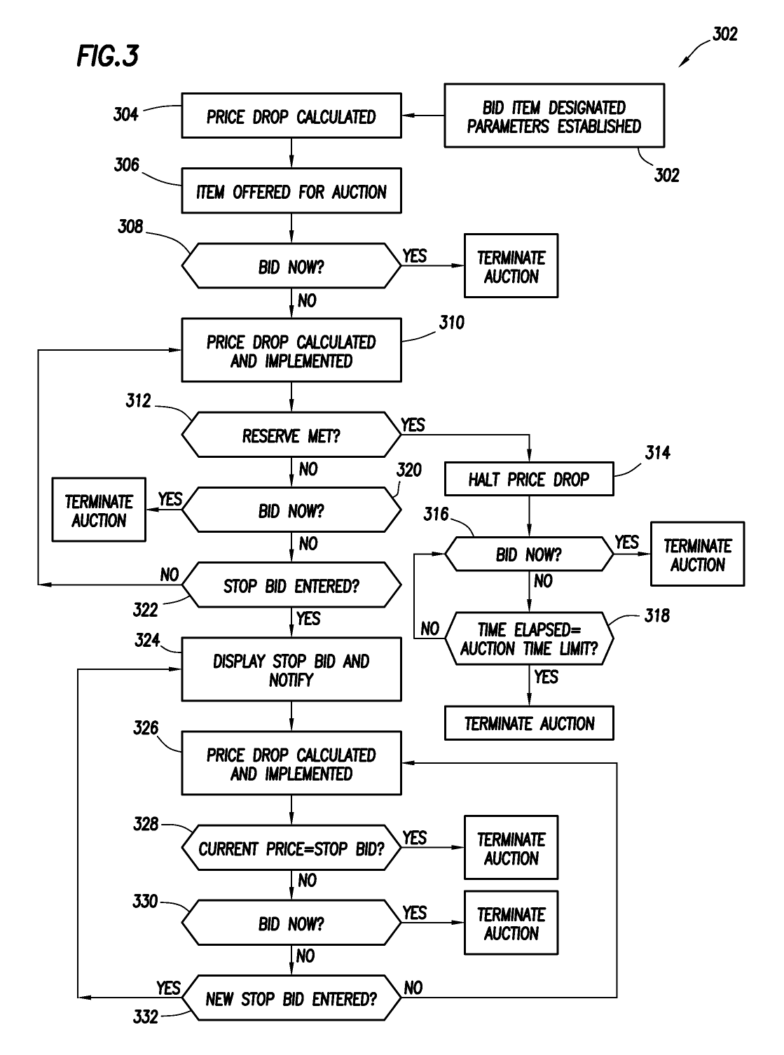

FIG. 3 is a somewhat simplified flow diagram illustrating method 300 of facilitating a hybrid descending-price auction according to one embodiment of the present disclosure. It should be understood that method 300 shown in FIG. 3 is for illustrative purposes only and that any other suitable method or sub-method could be used in conjunction with or in lieu of method 300 according to one embodiment of the present disclosure. It should also be understood that the steps of method 300 could be performed in any suitable order or manner.

In one embodiment, method 300 may generally be similar to method 200 shown in and described in conjunction with FIG. 2 above (with like operations having similar operations).

As such, method 300 begins in step 302 with a user designating an item for bid according to one embodiment of the present disclosure. In step 304, auction manager 126 analyzes the user-inputted parameters and calculates the price drop rate. In step 306, auction manager 126 engages the auction by displaying the item, item description, and a current asking price equal to the initial price defined by the user-inputted parameters.

In step 308, remote participants 140, viewing the item on their displays 142, may bid on an item at the then-current price by selecting “Bid Now” (or some other bidding mechanism) through their input devices 144. Once auction manager 126 determines a bid has been received at the current price, the auction manager 126 terminates the auction awarding the item to the bidder at the bid price.

In an embodiment, auction manager 126 may notify the winner by display message, electronic mail message, automated telephone message, instant message, text message, other suitable means, or any combination thereof. If desired, auction manager 126 may also notify one or more remote participants 140 who viewed the item by display message, electronic mail message, automated telephone message, instant message, text message, other suitable means, or any combination thereof.

If auction manager 126 determines a bid is not received at the current price, the price drop rate is calculated and implemented as shown in step 310. In particular, the price drop rate may be calculated according to any suitable scheme for adjusting and/or controlling the decrease in price over time. In this manner, the price drop rate may be dynamically adjusted during the auction.

Each time the price drops, auction manager 126 determines whether the current price is equal to the reserve price, as shown in step 312.

If the reserve price has not been met, then the process advances to step 320, as further described below.

In step 314, if it is determined that the reserve price has been met, auction manager 126 halts the price drop. Auction manager 126 may display that the reserve price has been met and/or notify one or more remote participants 140, who have viewed the item, by display message, electronic mail message, automated telephone message, instant message, text message, other suitable means, or any combination thereof, that the reserve price has been met.

In one embodiment, auction manager 126 may immediately terminate the auction when the reserve price has been met. Alternatively, however, as shown in FIG. 3, auction manager 126 may extend the auction for a predetermined period of time. According to this embodiment, in step 316, auction manager 126 recursively determines whether a bid is received at the reserve price before the extended auction time period has elapsed. If auction manager 126 determines a bid has been received at the reserve price, the auction manager 126 terminates the auction and awards the item to the bidder at the reserve price.

In an embodiment, auction manager 126 may notify the winner, and/or one or more remote participants 140 who viewed the item, by display message, electronic mail message, automated telephone message, instant message, text message, other suitable means, or any combination thereof.

If auction manager 126 determines that no bids are received and the time elapsed is equal to or greater than the user-inputted auction time period as shown in step 318, then auction manager 126 may terminate the auction and the item may not be awarded.

In step 312, if it is determined that the reserve price has not been met, the auction manager 126 will determine if a bid has been received, as shown in step 320.

Once auction manager 126 determines a bid has been received at the then-current price, the auction manager 126 terminates the auction and awards the item to the bidder at the bid price.

In an embodiment, auction manager 126 may notify the winner, and/or one or more remote participants 140 who viewed the item, by display message, electronic mail message, automated telephone message, instant message, text message, other suitable means, or any combination thereof.

If it is determined a bid is not received at the then-current price, the auction manager 126 determines if an “Offer” or “Stop Bid” has been entered by a remote participant 140, as shown in step 322. An Offer or Stop Bid (referred to herein as Stop Bid) is a bid with a value that is lower than the then-current price, but greater than or equal to the reserve price. Remote participants 140 may enter a Stop Bid at any time while the auction is active. Once a Stop Bid is established, a subsequent Stop Bid must have a value greater than any previous stop bid (or else it is of no consequence to the auction).

If no Stop Bid is received, then the process reverts to step 310.

However, if a Stop Bid is entered, auction manager 126 may display the Stop Bid value next to the item and/or notify one or more remote participants 140, who have viewed the item, by display message, electronic mail message, automated telephone message, instant message, text message, other suitable means, or any combination thereof, as shown in step 324. In one alternative, auction manager 126 may display a notice to one or more remote participants 140 that a Stop Bid has been entered but may withhold the value of the Stop Bid such that the remote participants 140 are unaware whether the then-current price is approaching the value of the Stop Bid. In another alternative, auction manager 126 may withhold the fact that a Stop Bid has been entered such that the remote participants 140 are unaware whether the auction is soon to terminate.

If auction manager 126 determines a bid is not received at the current price, the price drop rate is calculated and implemented as shown in step 310. In particular, the price drop rate may be calculated according to any suitable scheme for adjusting and/or controlling the decrease in price over time. In this manner, the price drop rate may be dynamically adjusted during the auction.

The price drop rate is then calculated and implemented as shown in step 326 (thereby dynamically adjusting the price drop rate during the auction). Each time the price drops, auction manager 126 determines whether the current price is equal to the Stop Bid value, as shown in step 328.

If the auction manager 126 determines that the then-current price is equal to the Stop Bid value, the auction manager 126 terminates the auction and awards the item to the “Stop Bid” bidder at the Stop Bid price.

In an embodiment, auction manager 126 may notify the winner, and/or one or more remote participants 140 who viewed the item, by display message, electronic mail message, automated telephone message, instant message, text message, other suitable means, or any combination thereof.

If it is determined that the then-current price is not equal to the Stop Bid value, the auction manager 126 will determine if a bid has been received, as shown in step 330.

If the auction manager 126 determines that a bid has been received, the auction manager 126 terminates the auction and awards the item to the “Bid Now” bidder at the bid price.

In an embodiment, auction manager 126 may notify the winner, and/or one or more remote participants 140 who viewed the item, by display message, electronic mail message, automated telephone message, instant message, text message, other suitable means, or any combination thereof.

In step 332, if it is determined a bid is not received at the current price, the auction manager 126 will determine if a new Stop Bid has been entered.

If the auction manager 126 determines that a new Stop Bid has been entered, then the process reverts to step 324. As noted above, in alternative embodiments, auction manager 126 may display the fact that a Stop Bid has been entered but withhold the value thereof, or may completely withhold the fact that a Stop Bid has been entered.

If the auction manager 126 determines in step 332 that a new Stop Bid has not been entered, then the process reverts to step 326.

In an embodiment, there may be a fee charged to a seller of an item posted for auction. The fee charged may be calculated based on a predetermined percentage of the final selling price of the item. However, in an alternate embodiment, the fee charged may be calculated based on a predetermined percentage of the reserve price of the item. One potential advantage of calculating the fee based on the reserve price is that a seller may be more likely to set a low reserve price. A low reserve price, in turn, may increase viewer interest in the auction because it may cause the price drop rate to be greater during one or more periods of the auction and/or may introduce the possibility that an item may sell for a lower price.

In another embodiment, characteristics of the remote participants 140 such as physical locations and past/current auction behavior may be tracked and displayed on a map for remote participants 140 to view. For example, a remote participant 140 can visually monitor information about the auction, including but not limited to location of remote participants 140 who have previously viewed the auction, location of remote participants 140 who have viewed the auction during the last 24 hours (or during some other period of time), location of remote participants 140 who are currently viewing the auction, location of remote participants 140 who have placed one or more Stop Bids on the item, and/or location of remote participants 140 who have requested that auction manager 126 notify them of activity in a particular auction. Auction manager 126 may also permit a remote participant 140 to select one or more other remote participants 140 from the map (or other user interface) to view past auction behavior of such other remote participants 140.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for generating a dynamically descending price auction and enabling remote bidding over the Internet via a facilitator, the method comprising the steps of:
a first step of receiving, from a user, bid item information related to a bid item and an initial price and storing the bid item information in a database;
a second step of analyzing the bid item information to calculate a price drop rate;
a third step of displaying the bid item, the bid item information and the initial price to a plurality of remote auction users at an Internet website and providing the bid item for auction;
a fourth step of presenting at least one query to the plurality of remote auction users and allowing plurality of remote auction users to request to buy the bid item at the starting price;
a fifth step of, if a request to buy the bid item is received, terminating the auction and notifying a winner;
a sixth step of, if no requests to buy the bid item are received, decreasing the initial price of the bid item based on the price drop rate to a current price until a request to buy the bid item at the current price is received; and
a seventh step of, terminating the auction and notifying a winner.

2. The method of claim 1, wherein the price drop rate is calculated with an algorithm based on price and time.

3. The method of claim 1, wherein the price drop rate is calculated with a algorithm allowing the price drop rate prior to the current price decreasing to a predetermined intermediate value to be greater than the price drop rate to the current price once the predetermined intermediate value is reached.

4. The method of claim 1, further comprising the step of recording each unique view of the auction by the plurality of remote auction users, and wherein the price drop rate is calculated with an algorithm that dynamically manipulates the price drop rate based on the unique views by the plurality of remote auction users.

5. The method of claim 1, further comprising the step of recording and analyzing each of the plurality of remote auction users that view the auction, and wherein the price drop rate is calculated with an algorithm that dynamically manipulates the price drop rate based on user characteristics of the plurality of remote auction users that view the auction.

6. The method of claim 5, wherein the user characteristics is comprised of at least one of registration, bidding probability, bidding history, and view history.

7. The method of claim 1, wherein the price drop rate is calculated with an algorithm that dynamically manipulates the price drop rate based on Internet website traffic related to the bid item compared to overall Internet website traffic.

8. The method of claim 1, further comprising the step of receiving, from the user, a reserve price, wherein the current price will not be decreased below the reserve price.

9. The method of claim 1, further comprising the step of receiving, from the user, an auction time limit, wherein the auction will terminate when the auction time limit has elapsed.

10. The method of claim 1, further comprising the step of recording personally identifiable information related to each of the plurality of remote auction users that view the auction and a location of plurality of remote auction users that view the auction.

11. The method of claim 10, further comprising the step of mapping the location of all of the plurality of remote auction users that view the auction, and displaying the map to the plurality of remote auction users.

12. The method of claim 1, wherein bid item information is comprised of at least one of item description, item picture, initial price, reserve price, auction time limit, and view related price drop speeds.

13. A method for generating a dynamically descending price auction and enabling remote bidding over the Internet via a facilitator, the method comprising the steps of:
a first step of receiving, from a user, bid item information related to a bid item and a initial price and storing the bid item information in a database;
a second step of analyzing the bid item information to calculate a price drop rate;
a third step of displaying the bid item, the bid item information and the starting price to a plurality of remote auction users at an Internet website and providing the bid item for auction;
a fourth step of presenting at least one query to the plurality of remote auction users and allowing the plurality of remote auction users to request to buy the bid item at a bid price;
a fifth step of, if a request to buy the bid item is received, determining whether the bid price is equivalent to the initial price;
a sixth step of, if the bid price is equivalent to the initial price, terminating the auction and notifying a winner;
a seventh step of, if the bid price is not equivalent to the starting price, decreasing the initial price of the bid item based on the price drop rate to a current price until the current price is equivalent to the bid price of any of the plurality of remote auction users; and
an eighth step of, if the current price is equivalent to the bid price, to terminate the auction and notifying a winner.

14. The method of claim 13, further comprising the step of, if the bid price is not equivalent to the initial price or the current price, displaying the bid price to the plurality of remote auction users.

15. The method of claim 13, further comprising the step of recording each unique view of the auction by the plurality of remote auction users, and wherein the price drop rate is calculated with an algorithm that dynamically manipulates the price drop rate based on the unique views by the plurality of remote auction users.

16. The method of claim 13, further comprising the step of recording and analyzing each of the plurality of remote auction users that view the auction, and wherein the price drop rate is calculated with an algorithm that dynamically manipulates the price drop rate based on user characteristics of the plurality of remote auction users that view the auction.

17. The method of claim 16, wherein the user characteristics is comprised of at least one of registration, bidding probability, bidding history, and view history.

18. The method of claim 13, wherein the price drop rate is calculated with an algorithm that dynamically manipulates the price drop rate based on Internet website traffic related to the bid item compared to overall Internet website traffic.

19. The method of claim 13, further comprising the step of receiving, from the user, a reserve price, wherein the current price will not be decreased below the reserve price.

20. The method of claim 13, further comprising the step of receiving, from the user, an auction time limit, wherein the auction will terminate when the auction time limit has elapsed.
